(19) United States
(12) Patent Application Publication
(10) Pub. No.: US 2014/0156867 A1
(43) Pub. Date: Jun. 5, 2014

(54) OFFLOAD PROCESSING INTERFACE

(71) Applicant: BROADCOM CORPORATION, Irvine, CA (US)

(72) Inventor: Shahram Davari, Los Altos, CA (US)

(73) Assignee: BROADCOM CORPORATION, Irvine, CA (US)

(21) Appl. No.: 13/692,072

(22) Filed: Dec. 3, 2012

(51) Int. Cl. H04L 12/56

(52) U.S. Cl. CPC H04L 45/44
USPC 709/238

(57) ABSTRACT

Disclosed are various embodiments providing offload processing circuitry of a network switch. The offload processing circuitry receives an administrative packet from a network switch, the offload processing circuitry being communicatively coupled to a network switch via an Ethernet interface. The offload processing circuitry identifies a receive offload header associated with the administrative packet, the receive offload header comprising a media access control (MAC) address associated with the offload processing circuitry. The offload processing circuitry updates a state machine based at least upon the administrative packet. The offload processing circuitry transmits packets to a network switch by encapsulating it in offload header. The network switch uses the offload header to forward the packet to a proper port.

### BACKGROUND

Network switches are used to route data from various sources and destinations in a computing environment. For example, a network switch receives network packets from one or more servers and/or network switches and route the network packets to other servers and/or network switches. While network packets include the substantive content that is communicated between various network switches and/or computing devices, network switches may also route Operations, Administration and Management (OAM) packets. OAM packets may require additional processing by a network switch.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is a drawing of an example of a networked environment, in accordance with various embodiments of the present disclosure.

FIG. 2 is a drawing of another example of the networked environment of FIG. 1, in accordance with various embodiments.

FIG. 3 is a flowchart illustrating an example of functionality implemented as portions of logic in a receive module of a network switch in the networked environment of FIG. 1, in accordance with various embodiments of the present disclosure.

FIG. 4 is a flowchart illustrating examples of functionality implemented as portions of logic in the offload processing circuitry in the networked environment of FIG. 1, in accordance with various embodiments of the present disclosure.

FIG. 5 is a flowchart illustrating an example of functionality implemented as portions of logic in a transmit module of a network switch in the networked environment of FIG. 1, in accordance with various embodiments of the present disclosure.

### DETAILED DESCRIPTION

The present disclosure relates to systems and methods for offloading packet processing from a network switch. Network switches receive multiple packets from a set of ports. It may be the case that some packets are administrative packets, where administrative packets require additional processing beyond that which is required by other network packets. The processing of these administrative packets may be offloaded from the network switch through the use of an offload processor (OLP).

According to various embodiments of the present disclosure, an OLP Rx (receive) module is used to detect administrative packets and route the administrative packets to an OLP for subsequent processing. The OLP interfaces with network switch via one of the ports used to receive packets by the network switch. In this respect, an OLP is configured to be directly connected to the network switch via any of the network packets ports. For example, the OLP may use an Ethernet port to plug into the network switch for providing the offload processing resources.

In various embodiments, the network switch encapsulates the administrative packets with one or more packet headers and routes the administrative packet to the OLP. The OLP may also respond to the receipt of an administrative packet by generating a reply packet in conformity with an administrative packet protocol.

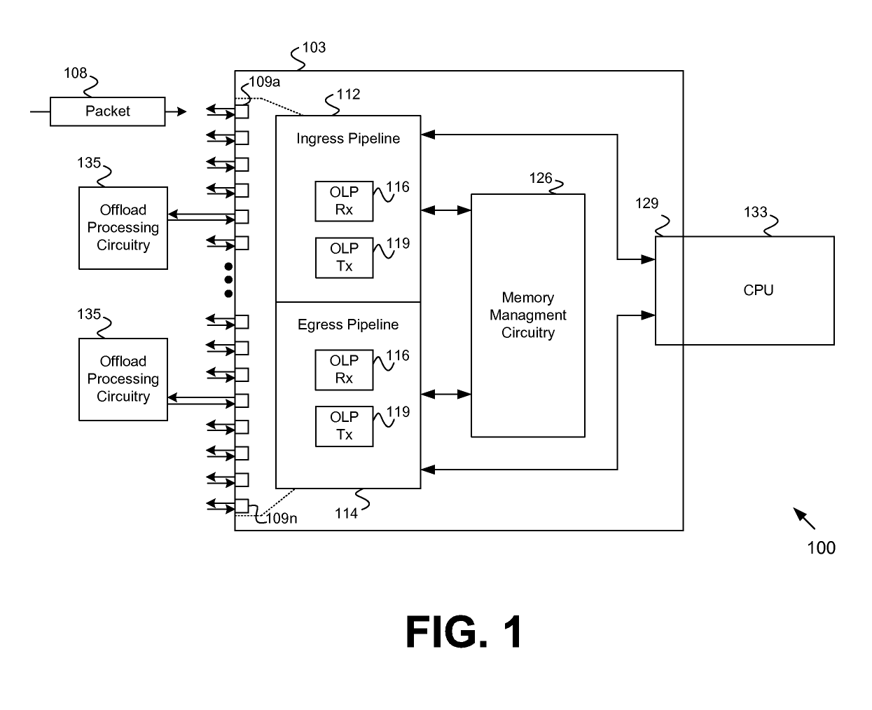

Reference is made to FIG. 1 which illustrates an example of a networked environment 100, in accordance with various embodiments of the present disclosure. The networked environment 100 includes network switch 103 that is configured to receive and send network packets. A network packet comprises any packet that is handled by the network switch 103 such as, for example, data packets, administrative packets 108, or any other packet. An administrative packet 108 may be, for example, an Operations, Administration and Management (OAM) packet, a time synchronization protocol packet, an Internet Protocol Security (IPsec) packet, an Alarm Indication Signal (AIS) packet, or any other special packet used to manage or otherwise administer the network.

The network switch 103 comprises a set of ports 109a-n for receiving and sending network packets. Each port 109 corresponds to a port identifier such as, for example, Port 1, Port 2, etc. In various embodiments, each port 109 is a bi-directional port. In this respect, Port 1, for example, comprises an ingress path for receiving network packets and an egress path for sending network packets away from the network switch 103. Additionally, each port 109 may comprise a local area network (LAN) interface such as, for example, an Ethernet interface for communicatively coupling to other network components.

The network switch 103 comprises an ingress pipeline 112 for handling network packets received by any of the ports 109 and an egress pipeline 114 for handling the transmission of network packets by the network switch 103. The network switch 103 comprises an OLP receive module 116 for routing administrative packets 108 received by the network switch 103 to one of the offload processing circuitry 135. The network switch 103 also comprises an OLP Tx (transmit) module 119 for routing administrative packets 108 received from the offload processing circuitry 135 that are to be sent out by the network switch 103. Portions of the receive module 116 and portions of the transmit module 119 may be implemented the ingress pipeline 112 and/or egress pipeline 114.

The network switch 103 further comprises memory management circuitry 126 that is configured to buffer, queue, prioritize, and schedule network packets received by the network switch 103. The network switch 103 also comprises a peripheral interface 129 for connecting the network switch 103 to peripheral devices. The peripheral interface 129 may be, for example, a Peripheral Connect Interface (PCI), a Universal Serial Bus (USB), or any other interface. The peripheral interface 129 is configured to provide connectivity between the network switch 103 and a central processing unit (CPU) 133. The CPU 133 may provide processing resources to the network switch 103 for processing network packets.

The networked environment 100 comprises offload processing circuitry 135 that is implemented within an OLP. The offload processing circuitry 135 is configured to be directly connected to the network switch 103 via any one of the ports 109. The offload processing circuitry 135 allows the network switch 103 to offload at least a portion of the processing of administrative packets 108 to the OLP.

Each of the components in the networked environment 100, such as, for example, the ingress pipeline 112, the egress pipeline 114, the receive module 116, the transmit module 119, the memory management circuitry 126, the CPU 133, the offload processing circuitry 135, and any other component may be implemented using one or more circuits, one or more microprocessors, application specific integrated circuits, dedicated hardware, digital signal processors, microcomputers, central processing units, field programmable gate arrays, programmable logic devices, state machines, or any combination thereof. In yet other embodiments, the various components in the networked environment 100 may include one or more software modules executable within one or more processing circuits. The components may further include memory configured to store instructions and/or code that causes the execution of network switching functions.

Next, a general description of the operation of the various components of the networked environment 100 is provided. The network switch 103 receives network packets via one or more of the ports 109. In the example where the ports 109 comprise Ethernet ports, the network packets are received via an Ethernet cable. The receive module 116 analyzes received network packets to determine whether a received network packet is an administrative packet 108 that must be terminated for processing. For example, the receive module 116 makes this determination based at least upon an Internet Protocol (IP) address, a Media Access Control (MAC) address, Virtual Local Area Network (VLAN) data, Ethertype field, or any other identifier or combination of identifiers associated with the received packet. To this end, particular identifiers (e.g., IP address, MAC address, etc.) associated with a received packet may be linked to an administrative packet 108.

A received packet that is determined to not be an administrative packet 108 that requires termination and processing is routed via the ingress pipeline 112 to the memory management circuitry 126 for data packet processing/scheduling. These packets are not processed by an OLP. When a received packet is an administrative packet 108, the receive module 116 prepares the administrative packet 108 to be routed to the offload processing circuitry 135 of an OLP. For example, the receive module 116 encapsulates the administrative packet 108 with one or more headers to route the administrative packet 108 to a particular OLP.

In various embodiments, the receive module 116 encapsulates the administrative packet with a receive OLP header. The receive OLP header comprises a receive port identifier for identifying the port 109 that received the administrative packet 108. The receive OLP header may comprise a timestamp for identifying a point in time of receipt of the administrative packet 108. The timestamp, for example, is a local with respect to the network switch 103 for allowing the network switch to determine a sequence of network packets received by the network switch 103. As another example, the timestamp is global and is generated in accordance with a time synchronization protocol such as, for example IEEE 1588. The receive OLP header may also comprise a counter sample representing a snapshot of a Loss Measurement Counter. The receive OLP header may further comprise a chip identifier for associating the administrative packet 108 to the network switch 103. The chip identifier may be used in a case where the administrative packet 108 is forwarded to other network switches for subsequent offload processing. This allows the OLP to determine the identity or identities of the network switch(es) 103 that handled the administrative packet 108.

The receive OLP header further comprises an OLP port 109. The OLP port is the port 109 that is responsible for connecting the offload processing circuitry 135 to the network switch 103. The offload processing circuitry 135 may be implemented in an OLP, where the OLP is configured to be communicatively coupled to any of the network switch ports 109. Once the OLP is connected or otherwise plugged into the network switch 103 via a particular port 109, that particular port 109 represents the OLP port 109 for sending administrative packet 108 to facilitate offload processing operations. To this end, the OLP port 109 is a dedicated port for offload processing while the OLP is connected to the network switch 103. In various embodiments, the OLP may be disconnected from the OLP port 109 and reconnected to another port 109, thereby updating the OLP port 109 to the other port 109. Also an OLP may be connected to a network switch 103 via multiple ports 109, where those ports 109 may be logically grouped together to create a larger port with more bandwidth.

In various embodiments, the receive module 116 encapsulates the administrative packet 108 with a LAN header such as, for example, an Ethernet header. The Ethernet header identifies a source MAC address and/or destination MAC address in accordance with an Ethernet protocol. In other embodiments, the receive module 116 includes VLAN data in the receive OLP header and/or LAN header. The VLAN data is used by the various components in the networked environment 100 to facilitate a virtual networking protocol for allowing administrative packets 108 and data packets to be sent along the same channel.

Once the administrative packet 108 is encapsulated with one or more headers, the receive module 116 routes the administrative packet 108 to the one of the plurality of ports to facilitate an offload processing of the administrative packet 108. For example, the ingress pipeline 112 sends the encapsulated administrative packet 108 to the memory management circuitry 126 for scheduling. Once scheduled, the encapsulated administrative packet 108 is routed to the OLP for offload processing by the offload processing circuitry 135.

The OLP is configured to connect to any of the ports 109 of the network switch 103. The OLP receives the encapsulated administrative packet 108 via one or more ports 109. The OLP comprises offload processing circuitry 135 to process the encapsulated administrative packet 108. For example, the offload processing circuitry 135 uses the receive OLP header for determining a manner in which to handle the encapsulated administrative packet 108. In various embodiments, processing the encapsulated administrative packet 108 comprises performing fault management, performing continuity checks, performing link layer discovery, monitoring/troubleshooting LAN access links, or any other process that involves updating a state machine. Once the offload processing circuitry 135 processes the encapsulated administrative packet 108, the offload processing circuitry 135 may drop the encapsulated administrative packet 108.

In various embodiments, the offload processing circuitry 135 is configured to generate a reply packet in response to processing the encapsulated administrative packet 108. The reply packet is generated based at least upon the content of the encapsulated administrative packet 108. The offload processing circuitry 135 also encapsulates the reply packet with a transmit OLP header for allowing the network switch 103 to properly handle the transmission of the reply packet.

In various embodiments, the transmit OLP header may comprise commands for the network switch 103 to sample a snapshot of timestamps and/or counters and insert them into the provided Offset location inside the packet 108. The transmit OLP header comprises a destination port 109 for specifying which one of the ports 109a-n is responsible for transmitting the reply packet. For example, if the OLP is connected to the network switch 103 via Port 10, then the transmit OLP header of a reply packet may specify a destination port of Port 7. The transmit OLP header further comprises a priority value, according to various embodiments, the priority value allows the memory management circuitry 126 to determine how to prioritize the reply packet according to a set of priority queues of the memory management circuitry 126.

Once a packet has been generated by the OLP and encapsulated with an appropriate transmit OLP header, the offload processing circuitry 135 sends the reply packet to the network switch 103 via one of the ports 109. In the case where each port 109 is a bi-directional port, the reply packet may be sent via the same port 109 in which the encapsulated administrative packet 108 was previously received.

The network switch 103 is configured to receive reply packets from one or more OLPs via corresponding ports 109. Specifically, a reply packet is received via the ingress pipeline 112. A portion of a transmit module 119 that is implemented as part of the ingress pipeline is configured to handle reply packets received from the offload processing circuitry 135. For example, the transmit module 119 performs a signature match on the reply placket to authenticate the reply packet. According to various embodiments, the signature match comprises authenticating the reply packet based at least upon an IP address, MAC address, Ethertype, or any other data associated with the reply packet. For example, the transmit module 119 determines that the source MAC address/source IP address of the reply packet matches the OLP that generated the reply packet.

Additionally, the transmit module 119 identifies the port or ports 109 that are responsible for transmitting the packet 108. The transmit module 119 analyzes the transmit OLP header to identify where to route the reply packet. In another embodiment, the transmit module 119 may identify the port or ports 109 that the packet 108 must be pretended to be received from and let the switch 103 forward the packet 108 similar to a data packet. It may be the case that the pretended receive port 109 is different than the port 109 to which the OLP is attached.

In various embodiments, the transmit module 119 removes the transmit OLP header from the reply packet, according to various embodiments. To this end, the use of OLP headers may be limited to communication between the offload processing circuitry 135 and the network switch 103. For example, once the packet is scheduled to be transmitted to a local port 109, for example, the OLP header is removed. The transmit module 119 then routes the reply packet to the destination port 109 identified in the transmit OLP header. In another embodiment, the packet 108 may be scheduled to be transmitted to a port 109 located on another remote network switch 103. In that case, the OLP Transmit header is to be removed by the remote network switch 103.

According to various embodiments, the network switch 103 is configured to connect to a CPU 133, where the CPU provides supplementary processing of administrative packets 108. In this respect, a portion of the administrative packet processing may be performed in the CPU. However, the CPU is not configured to be communicatively coupled to the network switch 103 via one of the ports 109. Thus, data communication between the network switch 103 and the CPU does not rely on the use of OLP headers.

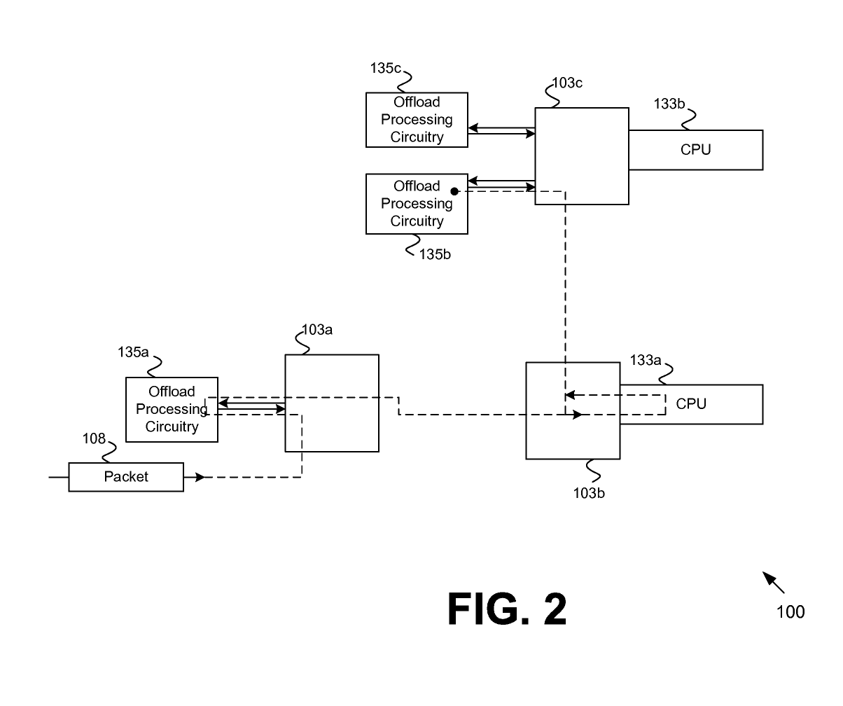

Moving on to FIG. 2, shown is another example of the networked environment 100, in accordance with various embodiments of the present disclosure. The networked environment 100 of FIG. 2 depicts multiple network switches 103a-c. The non-limiting example of FIG. 2 depicts a first network switch 103a that is directly connected to one OLP that comprises offload processing circuitry 135a. FIG. 2 further depicts a second network switch 103b that is not directly connected to an OLP. However, the second network switch 103b is connected to a CPU 133a via a peripheral interface 129 (FIG. 1). FIG. 2 also depicts a third network switch 103c that is directly connected to two offload processing circuitries 135b, c and a CPU 133b.

The third network switch 103c includes a first port 109 (FIG. 1) for communicatively coupling to a first OLP comprising offload processing circuitry 135b and a second port 109 for communicatively coupling to a second OLP comprising offload processing circuitry 135c. In this respect, the third network switch 103c is configured to connect to any number of OLPs via the network switch ports 109.

FIG. 2 provides an example of processing an administrative packet 108 using multiple OLPs across a variety of network switches. The first network switch 103a receives the administrative packet via a port 109. In various embodiments, a receive module 116 (FIG. 1) implemented in the first network switch 103a routes the administrative packet 108 to a destination port 109 that is communicatively coupled to the offload processing circuitry 135a. The administrative packet 108 is processed by the offload processing circuitry 135a and forwarded to the second network switch 103b. In other embodiments, the first network switch 103a forwards the administrative packet 108 to the second network switch 103b or the third network switch 103c without processing the packet in the offload processing circuitry 135a.

The second network switch 103b receives the administrative packet 108 from the first network switch 103a and forwards the administrative packet to a third network switch 103c. In various embodiments, the second network switch processes the administrative packet 108 using a CPU 133b.

The third network switch 103c receives the administrative packet. The receive module 116 of the third network switch 103c routes the administrative packet 108 to one of the OLPs. For example, the receive module 116 identifies the which OLP to route the administrative packet to based at least upon a type of operation performed by the offload processing circuitry 135b, c. The first offload processing circuitry 135b may be configured to process a first category of administrative packets while the second offload processing circuitry 135c may be configured to process a second category of administrative packets. As a non-limiting example, the first offload processing circuitry 135b is configured to process OAM packets while the second offload processing circuitry 135c is configured to process IPsec packets. Thus, depending on the category of the administrative packet 108, the receive module 116 routes the administrative packet to the appropriate offload processing circuitry 135b, c. To this end, the receive module 116 identifies the appropriate port 109 that corresponds to the correct OLP.

FIG. 2 provides another example of the operation of the OLPs in the networked environment 100 regarding the use of test packets. According to various embodiments, the offload processing circuitry 135 is configured to generate a test packet, encapsulate the test packet with a transmit OLP header, and send the test packet to other network switches 103 or other network components. A test packet is generated without being responsive to any received administrative packet 108. To this end, customers who wish to deploy test packets in a networked environment may design an appropriate OLP and plug it into any network switch 103 via a port, such as an Ethernet port of the network switch 103. Non-limiting examples of test packets include connectivity verification packets, and delay measurement packets. Test packets may be received by remote OLPs for facilitating network management, testing, troubleshooting, or maintenance. Reply packets may be generated in response to receipt of a test packet. In this respect, a test packet is an administrative packet 108 whose content is generated and originated by offload processing circuitry 135.

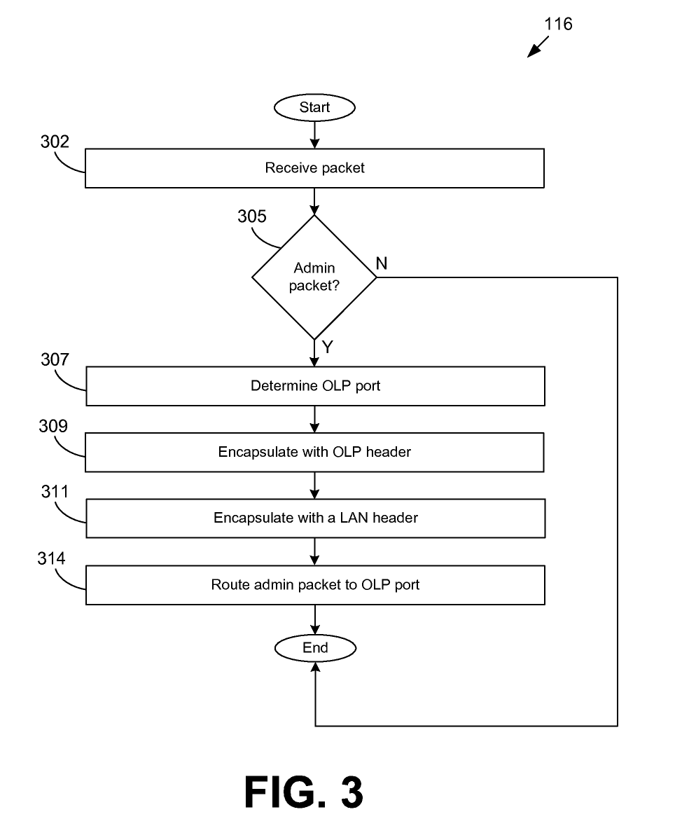

Turning to FIG. 3, shown is a flowchart illustrating examples of functionality implemented as portions of logic of a receive module 116 of FIG. 1, according to various embodiments of the present disclosure. It is understood that the flowchart of FIG. 3 provides merely an example of the many different types of functional arrangements that may be employed to implement the operation of the receive module 116 as described herein. As an alternative, the flowchart of FIG. 3 may be viewed as depicting an example of steps of a method implemented in the receive module 116 according to one or more embodiments.

To begin, the receive module 116 receives a packet (302). The packet is received via a port 109 (FIG. 1) of a network switch 103 (FIG. 1). The receive module 116 determines whether the packet is an administrative packet 108 (FIG. 1) that needs to be processed (305). The receive module 116 makes this determination based at least upon an address or identifier associated with the packet. If the packet is not an administrative packet 108 that needs to be processed, then the process depicted in the flowchart of FIG. 3 ends.

If the packet is an administrative packet 108 that needs to be processed, the receive module 116 determines an OLP port (307). The OLP port is a port 109 that is used to directly couple the offload processing circuitry 135 (FIG. 1) to the network switch 103. Once the offload processing circuitry 135 is connected to the network switch 103 via a particular port 109, the particular port 109 is then referred to as an OLP port. The receive module 116 identifies any port 109 that is coupled to the offload processing circuitry as an OLP port.

It may be the case that multiple OLPs are coupled to the network switch 103. To this end, each OLP is associated with a corresponding OLP port. In this case, the receive module 116 identifies the proper OLP based at least upon a type of operation to be performed on administrative packet 108 by the offload processing circuitry 135. The receive module 116 encapsulates the administrative packet 108 with an OLP header such as, for example, a receive OLP header (309). The receive OLP header, for example, comprises the OLP port that indicates the port 109 in which the administration packet is to be forwarded.

The receive module 116 also encapsulates the administrative packet 108 with a LAN header such as, for example, an Ethernet header (311). In various embodiments, the LAN header comprises a source MAC address, where the source MAC address specifies an address associated with the network switch 103. Also, the LAN header may comprise a destination MAC address that specifies the MAC address associated with the OLP that is scheduled to receive the administrative packet 108. In various embodiments, VLAN data is included in the LAN header or OLP header. The VLAN data is used for routing the administrative packet according to a VLAN protocol.

Once the administrative packet 108 is encapsulated, the administrative packet 108 is routed to the offload processing circuitry 135 of the destination OLP port (314). The administrative packet 108 is routed via memory management circuitry 126 (FIG. 1) where the administrative packet 108 is queued and scheduled. The administrative packet 108 is then routed via an egress pipeline 114 (FIG. 1) to the OLP port specified in the OLP header of the administrative packet 108. The administrative packet 108 is ultimately received by the offload processing circuitry 135 for processing the administrative packet 108.

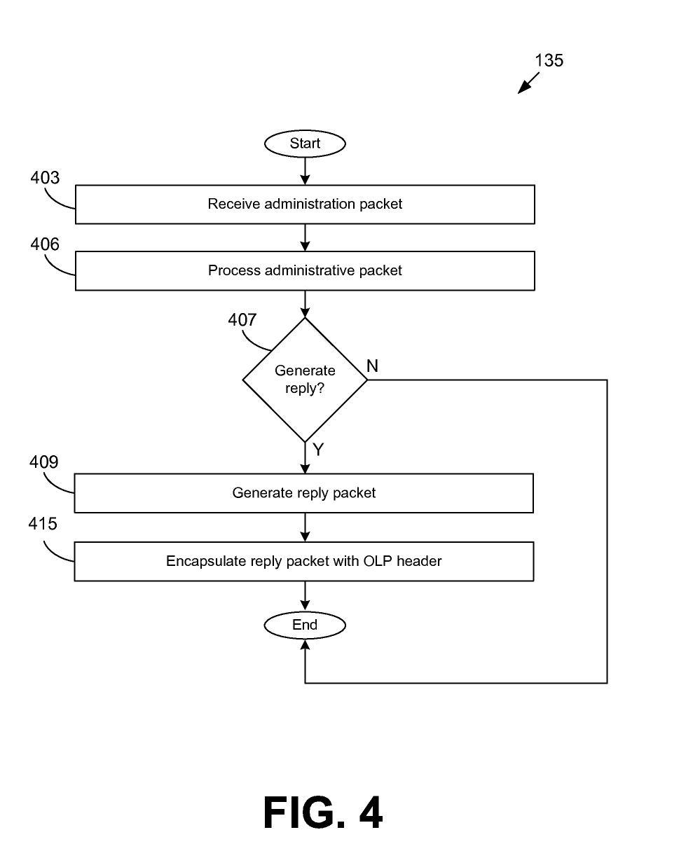

Referring next to FIG. 4, is a flowchart illustrating examples of functionality implemented as portions of logic of the offload processing circuitry 135 of FIG. 1, according to various embodiments of the present disclosure. It is understood that the flowchart of FIG. 4 provides merely an example of the many different types of functional arrangements that may be employed to implement the operation of the offload processing circuitry 135 as described herein. As an alternative, the flowchart of FIG. 4 may be viewed as depicting an example of steps of a method implemented in the offload processing circuitry 135, according to one or more embodiments.

To begin, the offload processing circuitry 135 receives an administrative packet 108 (403). The offload processing circuitry 135 is communicatively coupled to a network switch 103 (FIG. 1) via a network switch port 109 (FIG. 1) such as, for example, an Ethernet port. In various embodiments, the offload processing circuitry 135 is configured to be plugged into any of the network packet ports 109 of the network switch 103. The administrative packet 108 comprises an OLP receive header that was generated by the network switch 103.

The offload processing circuitry 135 processes the administrative packet 108 (406). For example, the offload processing circuitry 135 identifies the substantive content included in the administrative packet 108. Based at least upon this content, the offload processing circuitry 135 performs fault management, one or more continuity checks, link layer discovery, monitoring/troubleshooting of LAN access links, or any other process that involves updating a state machine. Once the offload processing circuitry 135 processes the administrative packet 108, the offload processing circuitry 135 may drop the administrative packet 108.

It may be the case that, based on the content of the administrative packet, the offload processing circuitry 135 must generate a reply packet (407). If no reply is needed, then the administrative packet is dropped and the process in the flow chart of FIG. 4 ends. If a reply packet is needed, then the offload processing circuitry 135 generates the reply packet (409). The offload processing circuitry 135 encapsulates the reply packet with an OLP transmit header such as, for example, a transmit OLP header (415). According to various embodiments, the transmit OLP header comprises a destination port 109 for specifying which one of the ports 109a-n is responsible for transmitting the reply packet. The transmit OLP header may further comprise a command to sample timestamp and/or sample counters, and/or a priority value for scheduling the reply packet in the network switch 103. The reply packet is transmitted from the offload processing circuitry 135 back to the network switch 103.

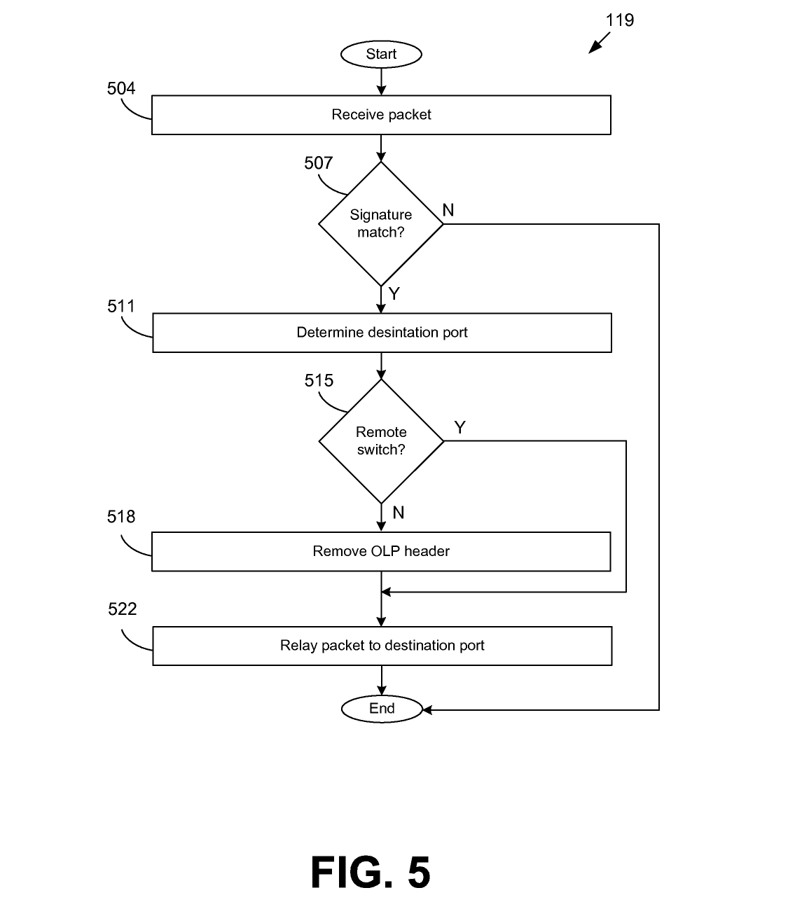

Turning to FIG. 5, is a flowchart illustrating examples of functionality implemented as portions of logic of a transmit module 119 of FIG. 1, according to various embodiments of the present disclosure. It is understood that the flowchart of FIG. 5 provides merely an example of the many different types of functional arrangements that may be employed to implement the operation of the transmit module 119 as described herein. As an alternative, the flowchart of FIG. 5 may be viewed as depicting an example of steps of a method implemented in the transmit module 119 according to one or more embodiments.

To begin, the transmit module 119 receives a packet (504). The packet is received from offload processing circuitry 135 (FIG. 1). The packet may be a reply packet generated by the offload processing circuitry 135, where the reply packet was generated in response to processing an administrative packet 108 (FIG. 1). The packet may also be a test packet generated by the offload processing circuitry 135, where the test packet is not in response to any packet received by the offload processing circuitry 135. The packet received by the transmit module 119 comprises an OLP header such as, for example, a transmit OLP header that was generated by the offload processing circuitry 135.

The transmit module 119 performs a signature match (507) to authenticate the received packet. For example, the transmit module 119 determines whether the packet originated from the offload processing circuitry 135 by analyzing a source MAC address, source IP address, or any other identifier that indicates an origin of the packet. To this end, the transmit module 119 determines the authenticity of the packet based at least upon the OLP header of the packet. If the packet does not match an expected signature, then the flowchart of FIG. 5 ends.

The transmit module 119 determines a destination port 109 (FIG. 1) associated with the packet (511). In one embodiment among others, the destination port 109 is included in the OLP header of the packet. The destination port 109 specifies one of the network switch ports 109 of the network switch 103 that is configured to send network packets through a networked environment 100 (FIG. 1). In another embodiment, the OLP Transmit header may identify the port or ports 109 that the packet 108 must be pretended to be received from. The OLP transmit header may further facilitate forwarding the packet 108 by the network switch 103 in a manner similar to forwarding a data packet received from that port.

The transmit module 119 determines whether the packet is to be forwarded to a remote port 109 that is implemented at a remote network switch 103 (515). For example, the OLP header of the packet may indicate that the packet is to be forwarded to the remote network switch 103. If this is not the case, then the transmit module 119 removes the OLP header of the packet (518) and then routes the packet to the destination port 109 (522).

However, if this is the case, then the transmit module 119 maintains the OLP header of the packet. Thereafter, the transmit module 119 routes the packet to the remote network switch 103. Then, the transmit module 119 of the remote network switch 103 removes the OLP transmit header and forwards the packet to its local destination port 109 (522). To this end, the packet is forwarded along a path towards the remote network switch 103 while maintaining the OLP header of the packet.

The flowcharts of FIGS. 3-5 show the functionality and operation of an implementation of portions of the receive module 116, offload processing circuitry 135, and transmit module 119, respectively. If embodied in software, each item may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as the receive module 116, offload processing circuitry 135, and transmit module 119. The machine code may be converted from the source code, etc. If embodied in hardware, each item may represent a circuit or a number of interconnected circuits to implement the specified logical function(s).

Although the flowcharts of FIGS. 3-5 show a specific order of execution, it is understood that the order of execution may differ from that which is depicted. For example, the order of execution of two or more blocks may be scrambled relative to the order shown. Also, two or more blocks shown in succession in FIGS. 3-5 may be executed concurrently or with partial concurrence. Further, in some embodiments, one or more of the items shown in FIGS. 3-5 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that comprises software or code, for example, the receive module 116, offload processing circuitry 135, and transmit module 119, may be embodied in any non-transitory computer-readable medium for use by or in connection with an instruction execution system such as, for example, the receive module 116, offload processing circuitry 135, and transmit module 119, in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, at least the following is claimed:

1. A system comprising:
a plurality of ports, each port being configured to receive packets; and
a receive module, the receive module being configured to:
determine whether a received packet is an administrative packet that requires processing;
encapsulate the administrative packet with an offload header, the offload header comprising a port identifier that specifies one of the plurality of ports; and
route the administrative packet to the one of the plurality of ports to facilitate an offload processing of the administrative packet.

2. The system of claim 1, wherein each port comprises an Ethernet port.

3. The system of claim 1, wherein the administrative packet is selected from a group consisting of an Operations, Administration and Management (OAM) packet, a time synchronization protocol packet, an Internet Protocol Security (IPsec) packet, and an Alarm Indication Signal (AIS) packet.

4. The system of claim 1, further comprising a peripheral interface configured communicatively coupled to a central processing unit (CPU) to provide a supplemental offload processing of the administrative packet.

5. The system of claim 1, wherein the receive module is further configured to encapsulate the administrative packet with an Ethernet header, the Ethernet header specifying at least one of a source Media Access Control (MAC) address or a destination MAC address.

6. The system of claim 1, wherein the offload header comprises virtual local area network (VLAN) data.

7. The system of claim 1, wherein encapsulating the administrative packet with the offload header comprises identifying the one of the plurality of ports based at least upon a type of operation performed by the offload processing.

8. The system of claim 1, wherein each port is configured to be communicatively coupled to a corresponding offload processor via an Ethernet interface, the offload processor being configured to perform the offload processing.

9. A system comprising:
a plurality of ports, wherein at least one of the plurality of ports is configured to be communicatively coupled to offload processing circuitry via a local area network (LAN) interface; and
a transmit module, the transmit module being configured to:
receive a packet via the at least one of the plurality of ports, the packet comprising an offload header;
authenticate the packet based at least upon a media access control (MAC) address associated with the offload header;
determine a destination port based at least upon the offload header; the plurality of ports comprising the destination port; and
route the packet to the destination port.

10. The system of claim 9, wherein the LAN interface comprises an Ethernet interface.

11. The system of claim 9, wherein the packet is selected from a group consisting of an Operations, Administration and Management (OAM) packet, a time synchronization protocol packet, an Internet Protocol Security (IPsec) packet, and an Alarm Indication Signal (AIS) packet.

12. The system of claim 9, wherein the transmit module is further configured to remove the offload header from the packet in response to a destination associated with the packet being local with respect to the transmit module.

13. The system of claim 9, wherein the transmit module is configured to authenticate the packet based at least upon an Ethertype included in the offload header.

14. The system of claim 9, wherein the offload header comprises virtual local area network (VLAN) data.

15. A method for offload processing circuitry, the method comprising:
receiving, by the offload processing circuitry, an administrative packet from a network switch, the offload processing circuitry being communicatively coupled to the network switch via an Ethernet interface;
identifying a receive offload header associated with the administrative packet, the receive offload header comprising a media access control (MAC) address associated with the offload processing circuitry; and
updating a state machine based at least upon the administrative packet.

16. The method of claim 15, further comprising:
determining whether to generate a reply packet based at least upon the received administrative packet; and
generating the reply packet and encapsulating the reply packet with a transmit offload header.

17. The method of claim 16, wherein the transmit offload header comprises a packet priority to prioritize the reply packet in the network switch.

18. The method of claim 16, wherein the transmit offload header comprises at least one of a timestamp or a counter.

19. The method of claim 15, further comprising:
generating a test packet and encapsulating the test packet with a transmit offload header, the test packet comprising a destination address; and
sending the test packet to the network switch via the Ethernet interface.

20. The method of claim 19, wherein the test packet is selected from a group consisting of a connectivity verification packet, a loopback packet, and a delay measurement packet.
